(19) United States
(12) Patent Application Publication
(10) Pub. No.: US 2008/0053603 A1
(43) Pub. Date: Mar. 6, 2008

(54) Method for High Definition Dip Transfer Printing

(76) Inventor: J. Patrick Epling, (US)

Correspondence Address: The Intellect Law Group, 2400 SE Federal Highway, Suite 340, Stuart, FL, 34994, US

(21) Appl. No.: 11/469,780

(22) Filed: Sep. 1, 2006

(51) Int. Cl. B41M 3/12; B05D 5/00

(52) U.S. Cl. 156/235; 427/146; 427/256; 156/277

(57) ABSTRACT

An invention for an improved method of high definition dip transfer printing of images to three-dimensional articles.

### FIELD OF THE INVENTION

This invention relates to an improved method for high definition dip transfer printing of images to three-dimensional articles.

### BACKGROUND OF THE INVENTION

Methods for high definition dip transfer printing of images to three-dimensional articles are well known in the prior art. Traditionally, the method for printing a high definition image on an article using transfer printing, as described in U.S. Pat. No. 6,953,511, involves printing an image from a digital image file onto a water soluble polymer film with solvent based ink to form a printed water soluble film using four color processing printing. Then placing the printed water soluble polymer film on water to at least partially dissolve the water soluble film, liquefying the solvent based ink image floating on the water with a solvent activator, and submerging the article in the water against the liquefied solvent based ink image to transfer the liquefied solvent based ink image to a surface of the article. The hydrostatic pressure of the water presses the liquefied solvent-based ink image against the outer surface of the article to transfer the image to the article. The article is then removed from the dipping tank, washed, and allowed to dry. Optionally the article can then be coated with a protective finish. There are several disadvantages attributable to the prior art methods. First, the prior art methods are very costly because there is a lot of scrap articles accumulated during the process because it is very difficult to maintain the tight registration of four-color process printing throughout the printing of an entire 1000-meter role of film and the registration problems are not evident until the image transfer is complete. Moreover, the water-soluble film is very susceptible to moisture and is extremely extensible. Therefore, the humidity, the water content of the film and pressure of the printing rollers also make it very difficult to hold the tight registration of the four color process printed images needed to result in a high definition image. The inability of the process printing method to hold tight registration does not allow the prior art to effectively or efficiently print images on PVA film and make it extremely difficult to print images on PVA film with high registration. To address these issues, the prior art teaches the use of excess ink, including a very heavy or thick top coat to make up for the uncontrolled registration, however this is not a complete or efficient solution to this problem. This method requires the use of substantially more activator, which increases the cost and also causes the image to weaken and transfer to the article inconsistently. Utilizing the present inventive method however, we are able to print any size PVA film up to and including 1.2 , 1.4 and 2 meter widths, enjoying high registration utilizing efficient and effective amounts of ink and activator.

Clearly there is a need for an improved method for high definition dip transfer printing of images to three-dimensional articles.

### SUMMARY OF THE INVENTION

The disclosed method presents a number of advantages over the prior art methods. First, the disclosed method is an improved process whereby the water soluble film is printed through a heat transfer process using heat transfer paper instead of printing the image directly to the water soluble film, as taught in the prior art methods. The disclosed method prints a high definition digital image onto heat transfer paper and then transfers the image onto the water-soluble polymer film.

By printing the image and the clear top coat to heat transfer paper and then transferring the image onto the water-soluble polymer film, the amount of ink required to print the digital images is greatly reduced, and therefore decreases the cost. Furthermore, the disclosed method allows the image to be printed with exacting registration and because the heat transfer paper and the water soluble film are bonded at the time of transfer the unstable characteristics of the film do not affect the film's printed image. Thus, the disclosed method eliminates the need for excess ink to make up for the uncontrolled registration and additional activator, which increases the cost and also causes the image to weaken and transfer to the article inconsistently.

The disclosed method further prints a thin or light clear top coat directly onto the heat transfer paper then prints the image on top of the clear coat so that when the image is transferred to the film, the top coat is immediately on top of the ink surface thereby controlling the wetting of the inks.

### BRIEF DESCRIPTION OF THE DRAWINGS

FIG. 1 is a view of the printing process method.

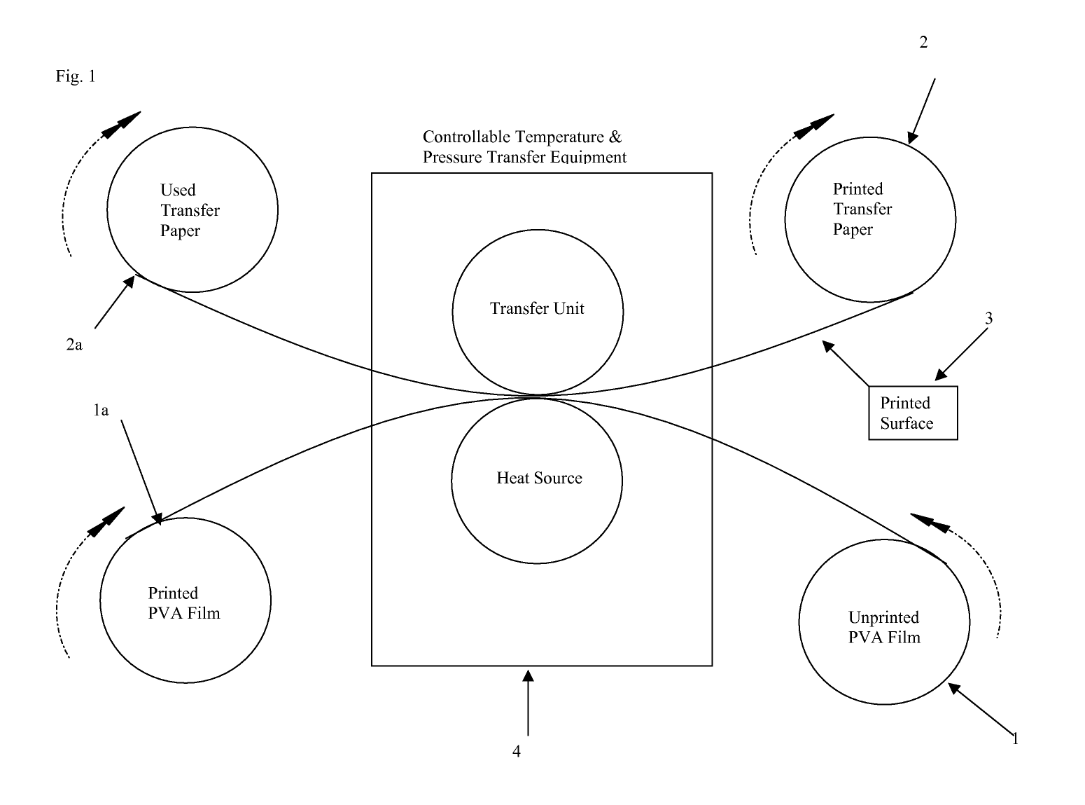

### DETAILED DESCRIPTION OF THE INVENTION

A modified Poly Vinyl Alcohol (PVA) film, hydrolyzed in an amount from about 40% to 90%, is used as the water soluble polymer film (1). A heat transfer paper (2) printed with the high definition digital image (3) and the unprinted PVA (1) feed through a heated roller system (4), the paper and the film contacting the roller, from about 2 to 20 seconds at a roller temperature of about 106 to 210 degrees Celsius. One skilled in the art will adjust both the volume of ink and activator and the pressure and temperature of the roller system during processing to achieve a consistent image run. The paper (2) and printed film (1) are separated upon exit from the heated rollers by the roller system (4) and the printed PVA film (1a) feeds to the finished stock roller system (5) where the film (1a) is cut to desired length, while the expended transfer paper (2a) is discarded.

What is claimed:

1. An improved method for high definition printing of an image on an article, the method comprising the steps of:
applying a clear top coat to heat transfer paper;
printing a digital image on top of the clear topcoat on the heat transfer paper;
transferring the image from the heat transfer paper to the water-soluble polymer film;
placing the printed water-soluble polymer film on water to at least partially dissolve the water-soluble film;
liquefying the solvent based ink image floating on the water with a solvent activator; and
submerging the article in water against the liquefied solvent based ink image to transfer the liquefied solvent-based ink image to a surface of the article.

2. The method of claim 1 wherein the water soluble polymer film is a modified PVA, hydrolyzed in an amount from about 40% to 90%.

3. The method of claim 1 wherein the water soluble polymer film is not less than 1.2 meters wide.

4. The method of claim 1 wherein the water soluble polymer film is not less than 1.4 meters wide.

5. The method of claim 1 wherein the water soluble polymer film is not less than 2 meters wide.

6. The method of claim 1 wherein the water soluble polymer film is a cold water soluble PVA.

7. The method of claim 1 wherein the heat transfer paper is printed in sheets.

8. The method of claim 1 where the step of transferring the image from the heat transfer paper to the water-soluble polymer film is accomplished by setting the heat transfer paper digital image down against the water-soluble polymer film and applying pressure with a heated surface.

9. The method of claim 1 where the step of transferring the image from the heat transfer paper to the water-soluble polymer film is accomplished by applying about two (2) seconds of pressure with a surface heated to about one hundred six degrees Fahrenheit (106 F).

10. An improved method for preparing a high definition image for transfer to an article, the method comprising the steps of:
applying a clear top coat to heat transfer paper;
printing a digital image on top of the clear topcoat on the heat transfer paper in preparation for the image transfer to the water-soluble polymer film.
